(19) United States
(12) Patent Application Publication
(10) Pub. No.: US 2014/0304446 A1
(43) Pub. Date: Oct. 9, 2014

(54) METHOD,SYSTEM AND APPARATUS FOR COMMUNICATING WITH AN ELECTRONIC DEVICE AND STEREO HOUSING

(71) Applicant: Robert Louis Fils, Los Gatos, CA (US)

(72) Inventor: Robert Louis Fils, Los Gatos, CA (US)

(21) Appl. No.: 13/858,511

(22) Filed: Apr. 8, 2013

(51) Int. Cl. G06F 1/16; G08C 17/02

(52) U.S. Cl. CPC G06F 1/1632; G08C 17/02
USPC 710/303; 340/12.5

(57) ABSTRACT

A stereo system comprises a housing for removably docking and housing an electronic device and a way communication device. The communication device comprises a receiver which is configured for receiving a command signal and a control device which receives a signal from the receiver and sends a signal to one or both of an electronic device operation circuit and a stereo housing operation circuit based upon the signal sent to the receiver. In some embodiments, the command signal sent to the receiver is a voice command. Sending a command signal to the receiver and the communication device enables a user to control one or both of the electronic device and the stereo housing. In some embodiments, the communication device is configured to receive a signal from the electronic device and the stereo housing.

### FIELD OF THE INVENTION

The present invention relates to controlling an electronic device coupled to a docking station or stereo system. More particularly, the present invention relates to remotely controlling an electronic device and a hermetically sealed docking station or stereo system.

### BACKGROUND OF THE INVENTION

Portable digital media players and electronic devices allow consumers to carry their music and other media with them wherever they go. Devices such as the iPod™, iPhone™ and other electronic devices are rapidly gaining popularity. Particularly, it is often desirable for a user to listen to music or use their electronic device in numerous locations, such as in the car, outside, or while performing an activity. In order to enhance the use of the electronic device, it is often connected to an external audio system or docking station. In some instances, a user is able to place the electronic device in one location and communicate with an audio system which is located in a separate location. Alternatively, the electronic device is coupled with a docking station and played through a speaker system of the docking station. However, once the electronic device is coupled with the external audio system or docking station it is difficult to control the electronic device as the user moves around or accomplishes a task.

### SUMMARY OF THE INVENTION

Embodiments of the present invention are directed to an apparatus, system and method for remotely communicating with an electronic device and a hermetically sealed stereo system. The stereo system comprises a housing for removably docking and housing an electronic device and a communication device. The communication device comprises a receiver which is configured for receiving a command signal and a control device which receives a signal from the receiver and sends a signal to one or both of an electronic device operation circuit and a stereo housing operation circuit based upon the signal sent to the receiver. In some embodiments, the command signal sent to the receiver is a voice command. Sending a command signal to the receiver and the communication device enables a user to control one or both of the electronic device and the stereo housing. In some embodiments, the communication device is configured to receive a signal from the electronic device and the stereo housing.

In one aspect, a communication device for an apparatus for docking and completely housing a removable electronic device comprises a receiver for receiving a command signal and a control device that receives a signal from the receiver and sends a signal to one or both of an electronic device operation circuit and a stereo housing circuit. In some embodiments, the device is a component of the apparatus. In some embodiments, the apparatus is ingress protection rated. In further embodiments, the device is removable from the apparatus. In some embodiments, the receiver is a microphone and receives voice commands. Alternatively, in some embodiments, the device comprises a remote control In some embodiments, the remote control is hermetically sealed from water and environmental intrusion. In further embodiments, the control device sends a wireless signal. In some of these embodiments, the signal comprises one or more of infrared, infrared laser, radio frequency, wireless, WiFi, and Bluetooth®. In some embodiments, the control device sends a signal to answer, hang up or make a phone call with the electronic device. In further embodiments, the control device sends a signal to start, stop, pause, or adjust the volume of media being played by the apparatus. In some embodiments, the communication device is configured to receive a signal from the electronic device and the apparatus.

In another aspect, a stereo system comprises a housing for removably docking and housing an electronic device and a communication device comprising a receiver for receiving a command signal and a control device that receives a signal from the receiver and sends a signal to one or both of an electronic device operation circuit and a stereo housing circuit. In some embodiments, the electronic device is completely enclosed within the housing. In some embodiments, the housing is ingress protection rated. In further embodiments, the communication device is a component of the housing. In some embodiments, the receiver is a microphone and receives voice commands. In further embodiments, the receiver receives commands from one or more buttons connected to the system. Alternatively, in some embodiments, the communication device comprises a remote control. In some embodiments, the remote control is hermetically sealed from water and environmental intrusion. In some embodiments, the control device sends a wireless signal. In some of these embodiments, the signal comprises one or more of infrared, infrared laser, radio frequency, wireless, WiFi, and Bluetooth®. In some embodiments, the control device sends a signal to answer, hang up or make a phone call with the electronic device. In further embodiments, the control device sends a signal to start, stop, pause, or adjust the volume of media being played by the apparatus. decrease the volume or increase the volume of media being played by the apparatus. In some embodiments, the stereo system is coupled to a spa or a boat. In further embodiments, the housing is hermetically sealed from water and environmental intrusion. In some embodiments, the communication device is configured to receive a signal from the electronic device and the apparatus.

In a further aspect, a method of remotely controlling an electronic device and a hermetically sealed stereo housing comprises coupling the electronic device with the housing, receiving a signal at a receiver coupled to the electronic device and the stereo housing and sending a signal to one or both of an electronic device operation circuit and a stereo housing circuit based upon the received signal in order to operate one or both of the electronic device and the stereo housing. In some embodiments, coupling the electronic device with the stereo housing comprises inserting the electronic device into the stereo housing and completely enclosing the electronic device. In some embodiments, the signal received by the receiver is a voice command. In some embodiments, a signal is received at a remote control based upon the signal sent to one or both of the electronic device operation circuit and the stereo housing circuit.

In still a further aspect, an ingress protection rated stereo system for use within an aquatic environment comprises a stereo housing unit coupled to one or more of an amplifier, a receiver and speakers, a communication device attached to the housing for communicating with an electronic device and comprising a microphone for receiving a voice command and a system control unit for controlling the electronic device or the stereo housing unit based upon the voice command received by the microphone.

In another aspect, a two-way remote control for a stereo housing unit and an electronic device comprises a remote control body comprising a microphone, a controller and a speaker for receiving media from the stereo housing unit and the electronic device. In some embodiments, the microphone receives a voice command to operate the electronic device. In some embodiments, the microphone and the speaker are used for a two-way phone call. In further embodiments, the speaker plays audio media. In some embodiments, the electronic device is completely enclosed within the housing unit. In some embodiments, the two-way remote control is hermetically sealed from water and environmental intrusion.

### BRIEF DESCRIPTION OF THE DRAWINGS

FIG. 1 illustrates a stereo system in accordance with some embodiments.

FIG. 2 illustrates a schematic view showing the components of a communication system for a stereo housing an electronic device in accordance with some embodiments.

FIG. 3 illustrates a method of remotely operating a stereo housing and an electronic device in accordance with some embodiments.

FIG. 4 illustrates a remote control in communication with a housing unit and an electronic device, in accordance with some embodiments.

### DETAILED DESCRIPTION OF THE PREFERRED EMBODIMENT

In the following description, numerous details and alternatives are set forth for purpose of explanation. However, one of ordinary skill in the art will realize the invention is able to be practiced without the use of these specific details. Particularly, one of ordinary skill in the art will recognize that some embodiments of the invention are able to be practiced with other electronic systems and components. Throughout the description similar components are similarly marked in order to aid comprehension.

Embodiments of the present invention are directed to an apparatus, system and method for remotely communicating with an electronic device and a stereo system. In some embodiments, the stereo system is hermetically sealed and ingression protection rated. In these embodiments, the stereo system is completely sealed from water and environmental intrusion. The stereo system comprises a housing for removably docking and housing an electronic device and a communication device. The communication device comprises a receiver which is configured for receiving a command signal, and a control device which receives a signal from the receiver and sends a signal to one or both of an electronic device operation circuit and a stereo housing operation circuit based upon the signal sent to the receiver. In some embodiments, the command signal sent to the receiver is a voice command. Sending a command signal to the receiver and the communication device enables a user to control one or both of the electronic device and the stereo housing. In some embodiments, the communication device comprises a remote control. In some embodiments, the remote control is hermetically sealed and ingression protection rated. In these embodiments, the remote control is completely sealed from water and environmental intrusion.

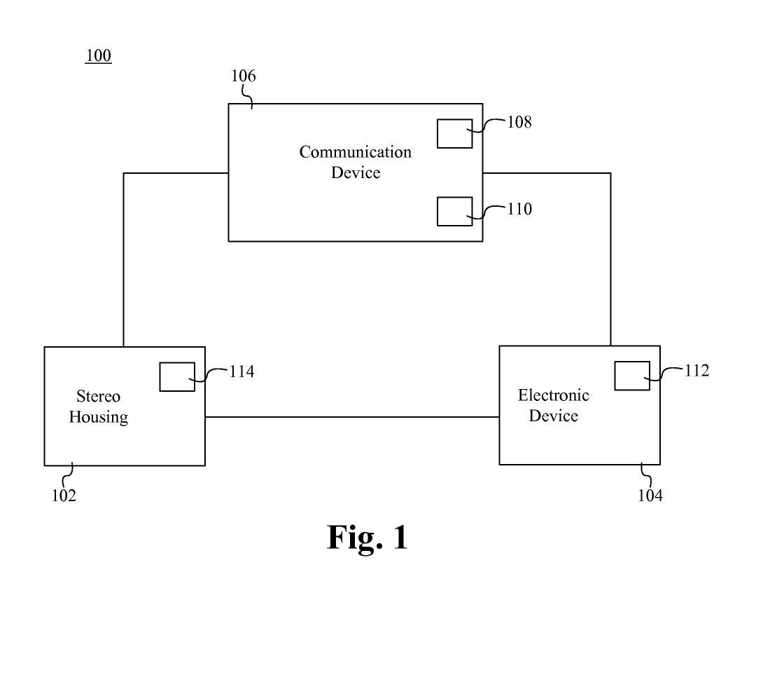

FIG. 1 illustrates a stereo system in accordance with some embodiments. The system 100 comprises a stereo housing 102 for removably coupling with an electronic device 104 and a communication device 106. In some embodiments, the stereo housing 102 comprises an apparatus for housing a removable electronic device such as described in the co-owned U.S. Pat. No. 7,831,756 and the co-owned U.S. patent application Ser. No. 12/915,967, and entitled “Docking Station for an Electronic Device”, both of which are hereby incorporated by reference. In these embodiments, when the electronic device 104 is coupled with the stereo housing 102, the electronic device 104 is docked within and completely enclosed within an enclosure of the stereo housing 102. Alternatively, in some embodiments, the electronic device 104 is wirelessly coupled with the stereo housing 102. In some embodiments the electronic device 104 is a portable digital media device such as an iPod™, Palm™, Zen™, Zune™, or other digital media device such as a tablet, MP3 player or music phone. Particularly, the electronic device 104 is able to comprise any appropriate electronic media player as known in the art. The stereo housing 102 is able to be coupled to one or more of an amplifier, a receiver and speakers in order to power the system. In some embodiments, the system 100 is ingress protection rated and is designed for use in an aquatic environment such as a boat or a spa. In some embodiments, the stereo housing 102 comprises a display screen and is configured to display video files.

In some embodiments, the communication device 106 comprises a receiver 108 for receiving a command signal and a control device 110 for controlling the device 106. The receiver 108 receives a command signal and sends a signal to the control device 110 based upon the command signal. The control device 110 processes the signal from the receiver 106 and sends a sends a signal to one or both of an electronic device operation circuit 212 and a stereo housing operation circuit 214.

As shown within FIG. 1, the two the communication device 106 is coupled to the stereo housing 102 and the electronic device 104. In some embodiments, the communication device 106 is a component of the stereo housing 102. In these embodiments, the device 106 is able to communicate with the electronic device 104 in a wired or wireless manner depending upon the connection of the electronic device 104 with the stereo housing 102. For example, if the electronic device 104 is docked with the stereo housing 102 then the device 106 is able to communicate with the electronic device 104 through the electronic device's 104 docking connection with the housing 102. Alternatively, in some embodiments, the communication device 106 communicates with the electronic device 104 in a wireless manner. Particularly, the communication device 106 is able to communicate with the electronic device 104 independent of the electronic device's 104 connection with the stereo housing 102. In further embodiments, the communication device 106 is separatable from the stereo housing 102. For example, in some embodiments, the device 106 comprises a remote control for controlling the stereo housing 102 and the electronic device 104. In some embodiments, the remote control is hermetically sealed and ingression protection rated. In these embodiments, the remote control is completely sealed from water and environmental intrusion. In some embodiments, the communication device 106 is able to receive one or more signals from the electronic device 104 and the stereo housing 102. For example, in some embodiments, the communication device 106 comprises a speaker and is able to play media from the stereo housing 102 and the electronic device 104 or answer and talk on a phone call received by the electronic device 106.

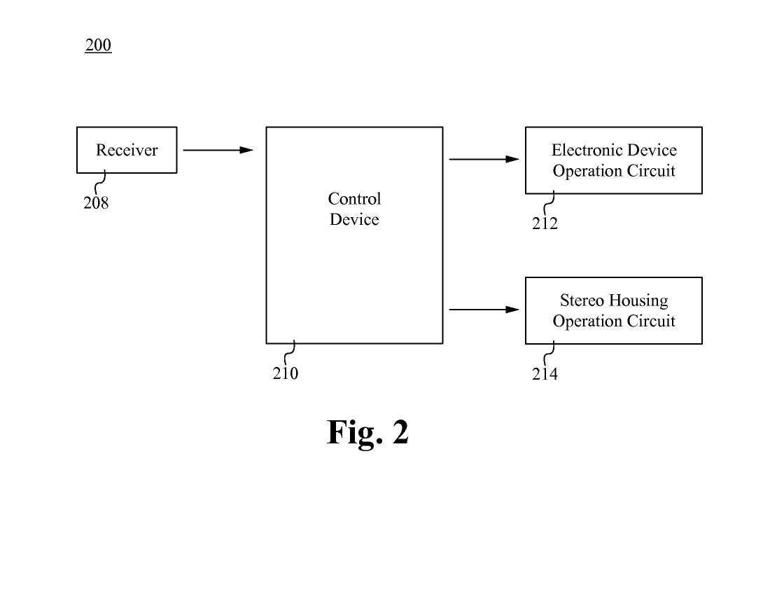

FIG. 2 illustrates a communication system for a stereo housing an electronic device in accordance with some embodiments. In some embodiments, the communication device 200 is for a hermetically sealed stereo housing or electronic docking station such as described above.

As shown in FIG. 2, the communication device 200 comprises a receiver 208, a control device 210, an electronic device operation circuit 212, and a stereo housing operation circuit 214. The receiver 208 receives a command signal and sends a signal to the control device 210 based upon the command signal. The control device 210 processes the signal from the receiver 208 and sends a signal to one or both of the electronic device operation circuit 212 and the stereo housing operation circuit 214. The electronic device operation circuit 212 operates an electronic device based upon the signal from the control device 210 and the stereo housing operation circuit 214 operates a stereo housing based upon the signal received from the control device 210. For example, in some embodiments, the receiver 208 receives a command to adjust the volume of a speaker system connected to the stereo housing. In response, the receiver 208 sends a signal to the control device 210 which processes the signal from the receiver 208 and sends a signal to the stereo housing operation circuit 214 to adjust the volume of the speaker system to a desired level. In some embodiments, the receiver 208 receives a signal to change the media that is playing through the stereo housing. In response, the receiver 208 sends a signal to the control device 210 which processes the signal from the receiver 208 and sends a signal to the stereo housing operation circuit 214 to change the media that is playing through the stereo housing. Particularly, the receiver 208 is able to receive and the control device 210 is able to send any appropriate control signal to the stereo housing operation circuit 214 as known in the art. For example, in some embodiments, the control device 210 sends a signal to the stereo housing to start, stop, pause, power up, or power down the stereo housing.

In further embodiments, the receiver 208 receives a command to operate the electronic device. For example, in some embodiments, the receiver 208 receives a command to answer or dial a phone call. In response, the receiver 208 sends a signal to the control device 210 which processes the signal from the receiver 208 and sends a signal to the electronic device operation circuit 212 to answer or dial the phone call. Particularly, when a user wishes to use the electronic device, the user is able to send a signal to the receiver to operate the electronic device in a desired manner using the components of the stereo housing.

In still further embodiments, the receiver 208 receives a command to operate the electronic device and the housing. For example, in some embodiments, the receiver 208 receives a command to power on or power off the electronic device and the stereo housing. In response, the receiver 208 sends a signal to the control device 210 which processes the signal from the receiver 208 and sends a signal to the electronic device operation circuit 212 and the operation circuit 214 to power on or power off the electronic device and the stereo housing.

In some embodiments, the receiver 208 is a microphone and is configured for receiving voice commands. Alternatively, in some embodiments, the receiver 208 comprises on or more push buttons which are pressed in order to control an aspect of one or both of the stereo housing and the electronic device. As described above, in some embodiments, the communication device is a component of the stereo housing. Alternatively, in some embodiments, the device is a component of a remote control for controlling the stereo housing and the electronic device.

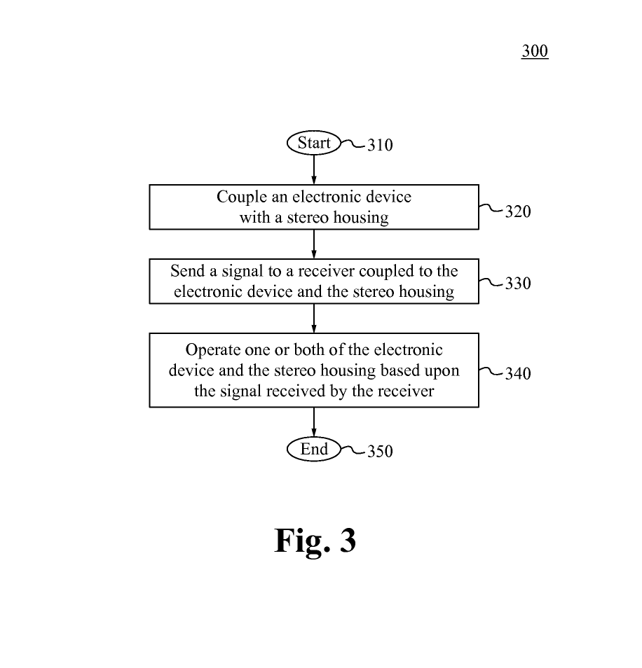

FIG. 3 illustrates a method of remote controlling an electronic device and stereo housing, in accordance with some embodiments. The method starts in the step 310. In the step 320, an electronic device is coupled with a stereo housing. In some embodiments, the electronic device is inserted into the stereo housing and completely enclosed within the housing. In some embodiments, the stereo housing is hermetically sealed and ingress protection rated. Particularly, the stereo housing is coupled to one or more of an amplifier, a stereo receiver and one or more speakers in order to play media located on the electronic device. Then, in the step 330, a signal is sent to a receiver coupled to the electronic device and the stereo housing. As described above, the receiver sends a signal to control device which process the signal from the receiver and sends a signal to one or both of an electronic device operation circuit and a stereo housing circuit. In the step 340, the electronic device, and/or the stereo housing is operated based upon the signal received by the receiver. In some embodiments, the receiver is a microphone and the signal is a voice command. Alternatively, in some embodiments the receiver comprises a remote control. In some embodiments, a signal is received at the remote control based upon the signal sent to one or both of the electronic device operation circuit and the stereo housing circuit. In some embodiments, the remote control is hermetically sealed and ingression protection rated. In these embodiments, the remote control is completely sealed from water and environmental intrusion.

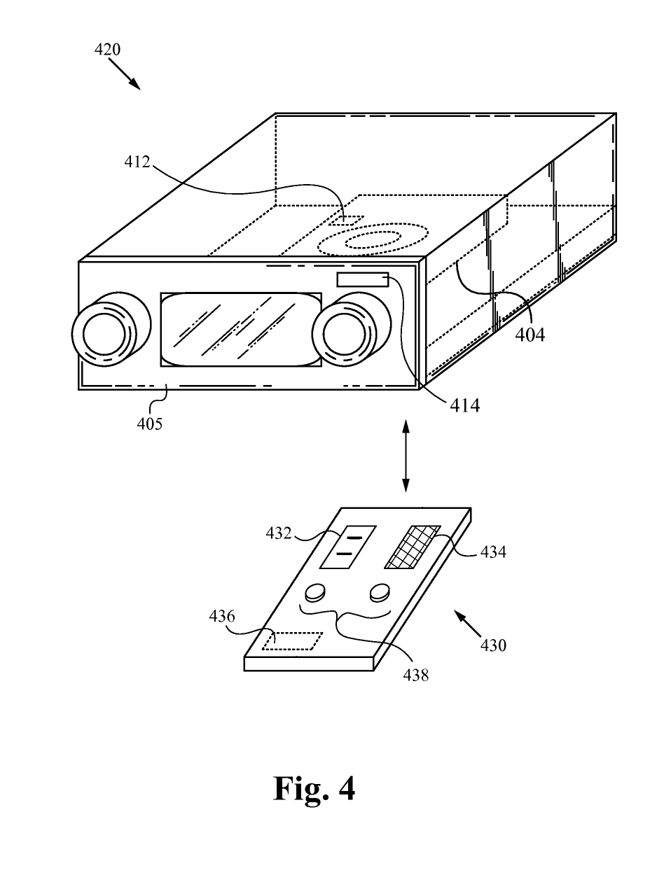

Referring now to FIG. 4, a remote control is shown in communication with a housing unit and an electronic device, in accordance with some embodiments. As shown in FIG. 4, an electronic device 402 has been removably coupled with a housing unit 420. In some embodiments, the electronic device 402 is completely enclosed within the housing unit 420 when it is coupled with the housing unit 420. In some embodiments, to connect the electronic device 402 with the housing unit 420, the user moves a controller interface 405 to an open position. The user then inserts the electronic device 402 into the housing unit 420 and couples the electronic device 402 with a device-housing connector inside the housing unit 420. The user then moves the controller interface 405 to a closed position, forming a waterproof enclosure housing the electronic device 402 within. In some embodiments, the controller interface 405 allows the user to operate the electronic device 402, now safely enclosed within the housing unit 420, and play content, such as music or other audio or video, through a connected audio system. Once the electronic device 402 is coupled within the housing unit 420, the user is able to access and control the functions of the electronic device 402 and the housing unit 420 by using the remote control 430. In some embodiments, the remote control 430 communicates with the electronic device 402 and the housing unit 420 with a wireless technology such as IEEE 802.11, Bluetooth®, Radio Frequency (RF) or any other appropriate wireless methodology.

The remote control 430 comprises a microphone 432 for receiving a voice command or other communication, a controller 436 and a speaker 434. In some embodiments, the remote control 430 is hermetically sealed and ingression protection rated. In these embodiments, the remote control 430 is completely sealed from water and environmental intrusion. In some embodiments, the microphone 432 receives a voice command or other communication from the user and sends a signal to the controller 436. The controller 436 processes the signal from the microphone 432 and sends a signal to one or both of the electronic device operation circuit 412 and the housing unit operation circuit 414. The electronic device operation circuit 412 operates an electronic device based upon the signal from the controller 436 and the housing unit operation circuit 414 operates the housing unit based upon the signal received from the controller 436.

For example, in some embodiments, the microphone 432 receives a voice command to adjust the volume of a speaker system connected to the housing unit 420. In response, the microphone 432 sends a signal to the controller 436 which processes the signal from the microphone 432 and sends a signal to the housing unit operation circuit 414 to adjust the volume of a speaker system coupled to the housing unit 420 to a desired level. In some embodiments, the microphone 432 receives a signal to change the media that is playing through the housing unit 420. In response, the microphone 432 sends a signal to the controller 436 which processes the signal from the microphone 432 and sends a signal to the housing unit operation circuit 414 to change the media that is playing through the stereo housing. Particularly, the microphone 432 is able to receive and the controller 436 is able to send any appropriate control signal to the housing unit operation circuit 414 as known in the art. For example, in some embodiments, the controller 436 sends a signal to the housing unit 420 to start, stop, pause, power up, or power down. In some embodiments, the media of the housing unit 420 is able to be played through the speaker 434. For example, a user is able to utilize the microphone 432 in order to send a voice command in order to play media through the speaker 434 of the remote control 430.

In further embodiments, the microphone 432 receives a command to operate the electronic device 402. For example, in some embodiments, the microphone 432 receives a command to answer or dial a phone call. In response, the microphone 432 sends a signal to the controller 436 which processes the signal from the microphone 432 and sends a signal to the electronic device operation circuit 412 to answer or dial the phone call. Particularly, when a user wishes to use the electronic device, the user is able to send a signal to the receiver to operate the electronic device 402 in a desired manner using the components of the stereo housing. Alternatively, in some embodiments, the phone call is received through the speaker 434 of the remote control 430. For example, a user is able to utilize the microphone 432 in order to send a voice command in order to receive a phone call through the speaker 434 of the remote control 430.

In still further embodiments, the microphone 432 receives a command to operate the electronic device and the housing. For example, in some embodiments, the microphone 432 receives a command to power on or power off the electronic device 402 and the housing unit 420. In response, the microphone 432 sends a signal to the controller 436 which processes the signal from the microphone 432 and sends a signal to the electronic device operation circuit 412 and the housing unit operation circuit 414 to power on or power off the electronic device 402 and the housing unit 420.

As shown in FIG. 4, in some embodiments, the remote control 430 comprises one or more buttons 438. The one or more buttons 438 are able to be used in order to send control signals to one or both of the electronic device 402 and the housing unit 420.

As described above, in some embodiments, the remote control 430 is used as a two-way remote control. In these embodiments, the remote control 430 sends signals to the electronic device 402 and the housing unit 420 and also receives signals from the electronic device 402 and the housing unit 420. Alternatively, in some embodiments, the remote control 430 is used to communicate signals to the electronic device 402 and the housing unit 420 in a one-way manner.

The present invention provides an easy and convenient way to play and control an electronic device and stereo housing as part of an audio system. Particularly, a user is easily able to play and control the electronic device while it is coupled with the stereo housing and stored in a convenient and secure location. In some embodiments, the electronic device is substantially hermetically sealed within the audio system such that a user is able to control the device in a wet environment such as a spa or boat with a waterproof remote control and without fear of damaging the audio system or the electronic device. Consequently, the user is able to enjoy use of the electronic device without worrying that the device may become damaged by water or environmental intrusion. Alternatively, in some embodiments, a user is able to couple the electronic device with an audio system and use a remote control in order to control the audio system and the electronic device in an indoor setting. Consequently, the present invention enables a user to conveniently utilize an electronic device and audio system in many different environmental settings. Accordingly, the stereo system described herein has numerous advantages.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention. Specifically, it will be apparent to one of ordinary skill in the art that the device and method of the present invention could be implemented in several different ways and have several different appearances.

What is claimed is:

1. A communication device for an apparatus for docking and completely housing a removable electronic device comprising:
a. a receiver for receiving a command signal; and
b. a control device that receives a signal from the receiver and sends a signal to one or both of an electronic device operation circuit and a stereo housing circuit.

2. The communication device of claim 1 wherein the device is a component of the apparatus.

3. The communication device of claim 2 wherein the apparatus is ingress protection rated.

4. The communication device of claim 1 wherein the device is removable from the apparatus.

5. The communication device of claim 1 wherein the receiver is a microphone and receives voice commands.

6. The communication device of claim 1 wherein the device comprises a remote control.

7. The communication device of claim 6 wherein the remote control is hermetically sealed from water and environmental intrusion.

8. The communication device of claim 1 wherein the control device sends a wireless signal.

9. The communication device of claim 8 wherein the signal comprises one or more of infrared, infrared laser, radio frequency, wireless, WiFi, and Bluetooth®.

10. The communication device of claim 1 wherein the control device sends a signal to answer, hang up or make a phone call with the electronic device.

11. The communication device of claim 1 wherein the control device sends a signal to start, stop, pause, or adjust the volume of media being played by the apparatus.

12. The communication device of claim 1 wherein the communication device is configured to receive a signal from the electronic device and the apparatus.

13. A stereo system comprising:
a. a housing for removably docking and housing an electronic device; and
b. a communication device comprising:
i. a receiver for receiving a command signal; and
ii. a control device that receives a signal from the receiver and sends a signal to one or both of an electronic device operation circuit and a stereo housing circuit.

14. The system of claim 13 wherein the electronic device is completely enclosed within the housing.

15. The system of claim 13 wherein the housing is ingress protection rated.

16. The system of claim 13 wherein the communication device is a component of the housing.

17. The system of claim 13 wherein the receiver is a microphone and receives voice commands.

18. The system of claim 13 wherein the receiver receives commands from one or more buttons connected to the system.

19. The system of claim 13 wherein the communication device comprises a remote control.

20. The system of claim 19 wherein the remote control is hermetically sealed from water and environmental intrusion.

21. The system of claim 13 wherein the control device sends a wireless signal.

22. The system of claim 21 wherein the signal comprises one or more of infrared, infrared laser, radio frequency, wireless, WiFi, and Bluetooth®.

23. The system of claim 13 wherein the control device sends a signal to answer, hang up or make a phone call with the electronic device.

24. The system of claim 13 wherein the control device sends a signal to start, stop, pause, or adjust the volume of media being played by the apparatus. decrease the volume or increase the volume of media being played by the apparatus.

25. The system of claim 13 wherein the stereo system is coupled to a spa or a boat.

26. The system of claim 13 wherein the housing is hermetically sealed from water and environmental intrusion.

27. The system of claim 13 wherein the communication device is configured to receive a signal from the electronic device and the housing.

28. A method of remotely controlling an electronic device and a hermetically sealed stereo housing comprising:
a. coupling the electronic device with the housing;
b. receiving a signal at a receiver coupled to the electronic device and the stereo housing; and
c. sending a signal to one or both of an electronic device operation circuit and a stereo housing circuit based upon the received signal in order to operate one or both of the electronic device and the stereo housing.

29. The method of claim 28 wherein coupling the electronic device with the stereo housing comprises inserting the electronic device into the stereo housing and completely enclosing the electronic device.

30. The method of claim 28 wherein the signal received by the receiver is a voice command.

31. The method of claim 28 wherein a signal is received at a remote control based upon the signal sent to one or both of the electronic device operation circuit and the stereo housing circuit.

32. An ingress protection rated stereo system for use within an aquatic environment comprising:
a. a stereo housing unit coupled to one or more of an amplifier, a receiver and speakers; and
b. a communication device attached to the housing for communicating with an electronic device and comprising:
i. a microphone for receiving a voice command; and
ii. a system control unit for controlling the electronic device or the stereo housing unit based upon the voice command received by the microphone.

33. A two-way remote control for a stereo housing unit and an electronic device comprising:
a. a remote control body comprising:
i. a microphone;
ii. a controller; and
iii. a speaker for receiving media from the stereo housing unit and the electronic device.

34. The two-way remote control of claim 33, wherein the microphone receives a voice command to operate the electronic device.

35. The two-way remote control of claim 33, wherein the microphone and the speaker are used for a two-way phone call.

36. The two-way remote control of claim 33, wherein the speaker plays audio media.

37. The two-way remote control of claim 33, wherein the electronic device is completely enclosed within the housing unit.

38. The two-way remote control of claim 33 wherein the remote control is hermetically sealed from water and environmental intrusion.
